(19) United States
(12) Patent Application Publication
(10) Pub. No.: US 2003/0131011 A1
(43) Pub. Date: Jul. 10, 2003

(54) Online regulatory compliance system and method for facilitating compliance

(75) Inventors: Gregory D. Haunschild, Katy, TX (US); Jon Eric Fields, Houston, TX (US)

Correspondence Address: Jo Katherine D' Ambrosio, D'Ambrosio & Associates, Suite 930, 2925 Briar Park Dr., Houston, TX, 77042, US

(73) Assignee: Argent Regulatory Services, L.L.C.

(21) Appl. No.: 10/145,490

(22) Filed: May 14, 2002

Related U.S. Application Data
(63) Continuation of application No. 60/345,238, filed on Jan. 4, 2002.

(51) Int. Cl. G06F 7/00

(52) U.S. Cl. 707/100

(57) ABSTRACT

A method and system for facilitating compliance with government regulations comprising the steps of providing a secured, interactive web site system hosted by at least one computer server. The web site system can comprise a network of computers with a server computer accessible by multiple computers at various geographic localities or a World Wide Web system having a computer server for storing and accessing compliance related data. One or more secured databases comprising governmental regulations, industry standards and company policies requiring compliance by client users are provided. Accessibility to the databases is preferably limited to authorized users. The one or more databases can also comprise substantially all subject items, facility sites, equipment and activities that require compliance with government rules and regulations, industry standards and company policies.

### CROSS REFERENCES TO RELATED CASES

This is a continuation of U.S. Provisional Patent Application, Serial No. 60/345,238 filed Jan. 04, 2002, now abandoned.

### FIELD OF INVENTION

The present invention relates to a system for online regulatory compliance system and method for facilitating regulatory compliance. Particularly, the invention is directed to a web-based system of regulatory compliance for industries subject to governmental laws and regulations by federal, state and local agencies, industry association standards and company policies.

### BACKGROUND

Automated systems of integrated computer programs for facilitating compliance with government rules and regulations are available for various government and industry organizations. Generally, pertinent references in this field relate to one of three categories: 1) systems for managing compliance with regulatory entities and/or equipment, 2) systems and methods for determining compliance with government regulations for chemical products and 3) tracking systems to determine compliance requirements for hazardous materials as part of an overall management system.

In U.S. Pat. No. 6,292,806, Sandifer discloses a computer based maintenance and repair information system for equipment subject to regulatory compliance, specifically for aircraft. The technical database comprises electronically stored publications and maintenance information for aircraft and components. The status of compliance with Airworthiness Directives and manufacturer service information is maintained for each component, allowing users to determine whether or not an aircraft is in compliance with airworthiness regulations. In the '806 patent, the maintenance and repair information may be on different CD-ROM discs and there is no electronic commingling of publications, see Col. 22, lines 5-14. Each publication must be individually searched for data regarding a specific component. See Col. 31, lines, 44-60.

The next group of disclosed patents relate to systems for compliance of chemical products. Petke et al. in U.S. Pat. No. 6,163,732 disclose a system, method and computer program for determining compliance of chemical products to governmental regulations. The chemical composition present in the chemical product to be manufactured is ascertained and compared to a stored set of government regulatory standards related to the chemical composition so that compliance can be determined. The regulatory databases are maintained and updated. The chemical composition is determined from manufacturing bills of materials. In U.S. Pat. No. 6,097,995 to Tipton et al., a hazardous materials and waste reduction management system is disclosed. The chemical management system includes a chemical inventory control system allowing a user to manage chemicals from a central station, to allow for the tracking of individual chemical containers throughout its life and an international chemical compatibility system with a compliance/education design to create compliance/education files for any country in the world. The system includes international hazardous material compatibility data stored on a computer for multi-tier compliance/education design data for creating files in any foreign language. The compliance data for chemicals is printed onto labels as well as compliance data for related safety equipment. The data represents a comparison of sampled data from an item of safety equipment compared to a set of standard criteria for performance of the item.

Wiitala et al., U.S. Pat. No. 6,122,622 disclose a computer aided system for compliance with chemical control laws. The system comprises a means for storing compliance information for substances, based on substance control laws of different jurisdictions having varying requirements and means for processing and program instructions to determine the compliance status for a product, based on the compliance information. This system is limited to chemical control law compliance.

None of the above-referenced patents discuss or resolve the problem of easy access to all rules, regulations and recommended procedures affecting a single plant, site or piece of equipment that emanate from a multitude of regulatory entities including state and federal agencies, industry associations and even a company's own policies and procedures directly relating to a facility site and its operations.

### SUMMARY

This invention relates to an innovative system for tracking and complying with government rules and regulations coming from both state and federal agencies, industry standards and company polices and procedures that affect a company or organization. The regulatory compliance system is comprehensive in that it compiles substantially all compliance rules and regulations for subject items within a facility, the subject items including facility sites, equipment and activities that may be regulated. Advantageously, the system comprises a series of software programs to enable the user to identify a subject item, an engine for example, and track substantially all government rules, regulations, industry standards and company policies and procedures affecting the engine to ascertain the required compliance, including the compliance action and due date. Preferably, the compliance rules and regulations are kept evergreen by periodic updating. One embodiment of the regulatory compliance system comprises:

(a) An interactive web site, accessible to clients by a LAN system or the World Wide Web, for a facility; preferably the system identifies subject items comprising substantially each site at the facility and substantially each piece of equipment and activity that are subject to compliance regulations for tracking government rules and regulations, industry standards and company policies for substantially each facility site, equipment and activity.

(b) A database that has substantially all government regulatory requirements, industry standards and company policies and procedures as well as related compliance information for each subject item listed by a user.

(c) A database engine comprising query, sort and find software to generate compliance data for identified sites, equipment and activities.

(d) A tracking system to notify a responsible party that the equipment, site or activity must comply with government and industry rules and regulations, industry standards and company policies. These rules and regulations can be updated periodically on the web site.

(e) Preferably, reminders such as emails are sent to the client companies and organizations regarding updates to rules and regulations and the requirements that must be followed to comply with the new regulations.

(f) The web site also determines plant and facility requirements, plant site or station, i.e. environmental regulations and requirements applying to site, such as waste management, soil maintenance, environmental safety and health site wide for employees and public.

Preferably, the web site explains the regulations for the equipment and facilities, identifies the person responsible for carrying out the compliance and determines the frequency of compliance actions. The system can have a trigger program to notify responsible parties of upcoming compliance due dates.

One preferred method for facilitating compliance with government regulations comprises the steps of providing a secured, interactive web site system hosted by at least one computer server. The web site system can comprise a network of computers with a server computer accessible by multiple computers at various geographic localities. Alternatively, the web site system can comprises a World Wide Web system having a computer server for storing and accessing compliance related data. One or more secured databases comprising governmental regulations, industry standards and company policies requiring compliance by client users are provided. In one aspect, the one or more secured databases can be relational databases. Accessibility to the databases is preferably limited to authorized users. The one or more databases can also comprise substantially all subject items, facility sites, equipment and activities that require compliance with government rules and regulations, industry standards and company polices.

A computer data processor having a database engine comprising query, sort and find functional software is used to apply rules requiring compliance to ascertain compliance requirements for substantially each subject item selected by a user. The compliance requirements are based upon government regulations, industry standards and company polices and procedures listed in the database. Preferably, the regulations, standards and policies are updated periodically so that the system is evergreen. The compliance requirement data that is ascertained for selected subject items can be provided to the authorized client users through various reports, graphs and checklists. Preset time triggers can also be used to notify responsible parties, by email, fax, phone or regular mail, of required compliance actions and due dates.

A report function is used to generate one or more reports. The compliance requirements, required actions and triggers are provided to a responsible person for carrying out compliance actions. The responsible person is notified regarding compliance requirement data and compliance dates by reminders. Preferably, the compliance requirement data is provided to a responsible person according to preset time triggers. The reports can comprise one or more checklists, one or more compliance tables, one or more equipment query reports, one or more site information reports, one or more equipment lists, one or more inventory reports and combinations thereof.

The system and method of this invention can be used by various organizations and companies that must comply with environmental rules and regulations or with any other government regulations, industry standards or recommended procedures or company in-house policies. For example, the online regulatory compliance system and method can be used for online environmental and safety compliance for petrochemical plants, automobile manufacturers, and auto repair shops, within construction businesses, education facilities and any other commercial facility requiring compliance with government regulations.

### BRIEF DESCRIPTION OF DRAWINGS

FIG. 1 is a schematic illustrating one system of this invention.

FIG. 2 is a flow chart of one embodiment of the method of this invention.

FIGS. 3-36 are print outs of web pages according to one embodiment of the method and system of this invention.

### DETAILED DESCRIPTION OF THE PREFERRED EMBODIMENTS

This invention relates to a web-based system and method for facilitating regulatory compliance for companies and organizations that must comply with government regulations, industry standards and recommended procedures as well as a company's own policies and procedures for its facilities. Advantageously, each client company or user organization using this system or method can have a secured location on a web site that is accessible only to authorized persons. The web site can be a local area network site or on a World Wide Web site that is accessible to authorized users world wide from multiple computers. In the practice of this invention, an individualized, evergreen compliance system for each facility is developed and periodically updated according to new rules and regulations that may issue.

One preferred method for facilitating regulatory compliance comprises providing a secured, interactive web site hosted by at least one computer server in communication with a computer network. The web site is accessible to multiple computer processors on a secured basis, namely, only authorized users have access. The interactive website, in this preferred embodiment, is an addressable network site that receives, stores, and processes data.

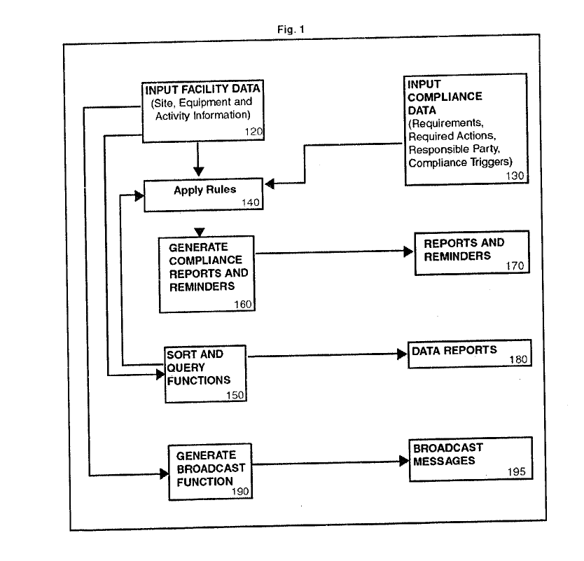

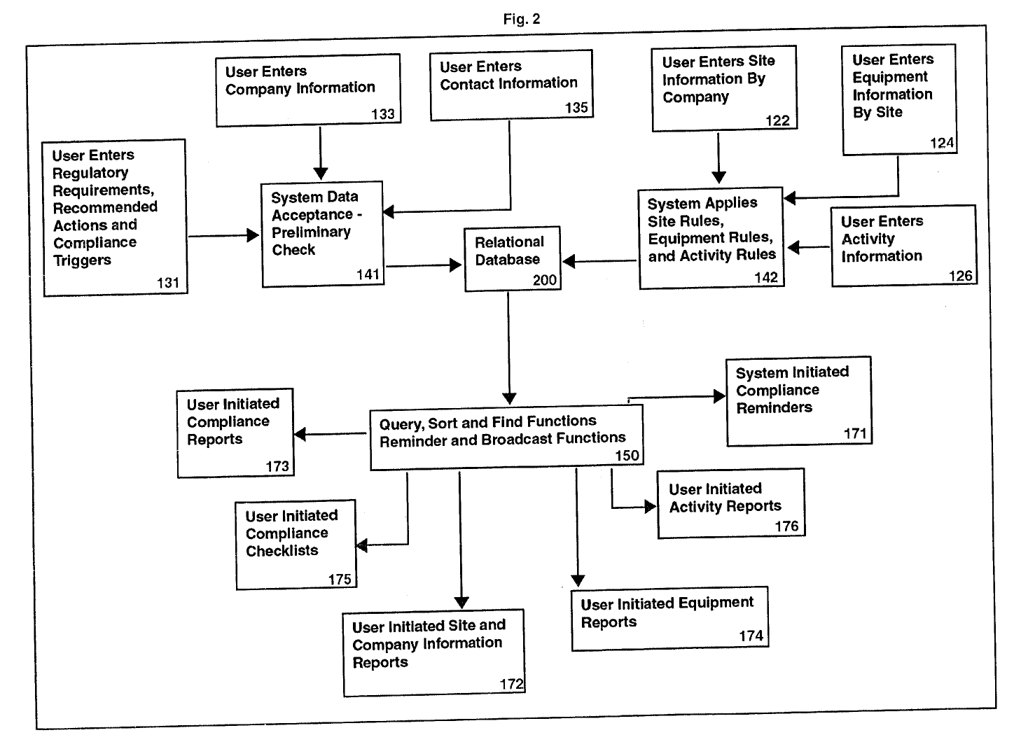

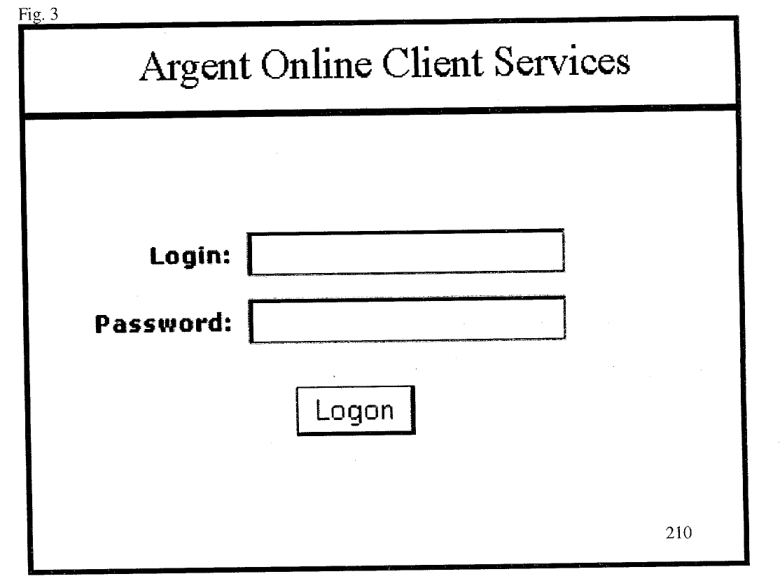

Referring to FIGS. 1 and 2, the method of this invention provides one or more databases 200 comprising regulatory compliance data and subject items. The databases can be relational or interactive databases 200. Accessibility to the one or more databases is limited to authorized users. The regulatory compliance data input into the system 131 comprises compliance requirements emanating from one or more laws, statutory codes, government rules, regulations, standards, procedures and guidelines of one or more regulatory authorities. These regulatory authorities comprise government legislatures, government agencies, industry associations such as the API in the petrochemical industry, as well as companies that mandate compliance with in-house policies and procedures. The regulatory compliance data 131 can further comprise recommended compliance actions to satisfy compliance requirements and due dates for actions for compliance. Certain compliance triggers are available to alert users to a required action and its due date, updating permits for example. Because new rules and regulations emanate frequently from the government and organizational entities, the database is preferably updated periodically so that the system is evergreen.

Preferably, the one or more databases within this regulatory compliance system further comprise subject item data, the subject items comprising facility sites 122, equipment 124 and activities 126 requiring compliance. This data can be comprehensive to include substantially all equipment that is used at a particular facility such as a petrochemical plant as well as the facility site itself (building requirements) and activities that may be regulated, atmospheric emissions, fuel burning and disposal of hazardous wastes for example. Client company or organization information data is also input into the one or more databases. This information can include geographic location, employee information, employee organizational charts, responsible persons for carrying out compliance for specific subject items, and contact information, addresses, phone numbers, email addresses and other information necessary to keep a company informed regarding timely compliance with rules and regulations. A system data preliminary check 141 can be performed by the software to determine completeness of information and data entered.

When an authorized user from a client company or organization accesses the web site, (s)he encounters a login page requiring authorization information such as a user name and password. Referring to FIG. 3, upon request for use of the compliance system, the interactive website software is programmed to initially authenticate the user by requesting and receiving authorization information such as client identification, passwords 210, or other means of identification from the requesting user. Sophisticated methods of securing access to the website, or means for authenticating can be employed, bodyscan coding, for example, is well know in the art. Bodyscan coding uses the client's eye, finger or hand prints to identify the service provider as an authorized user. One embodiment of the method and system of this invention is secured by using a combination of the operating system's built-in authentication methods and SQL server's database security. For distribution over the Internet, it will be best served by the use of Secure Sockets Layer (SSL) protocol. A “Server Certificate” can be registered.

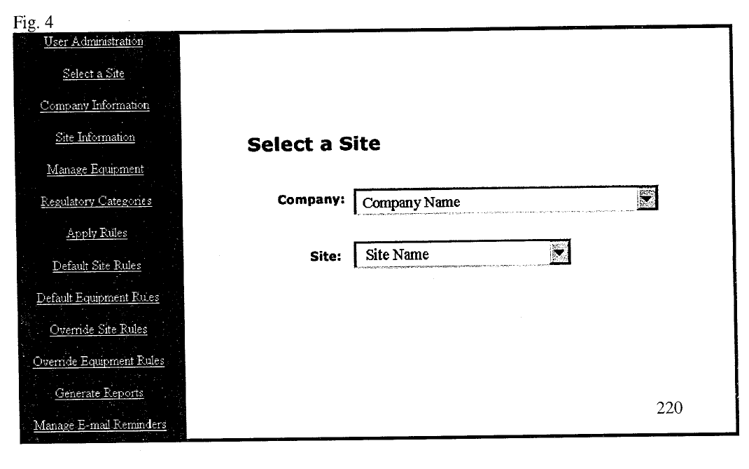

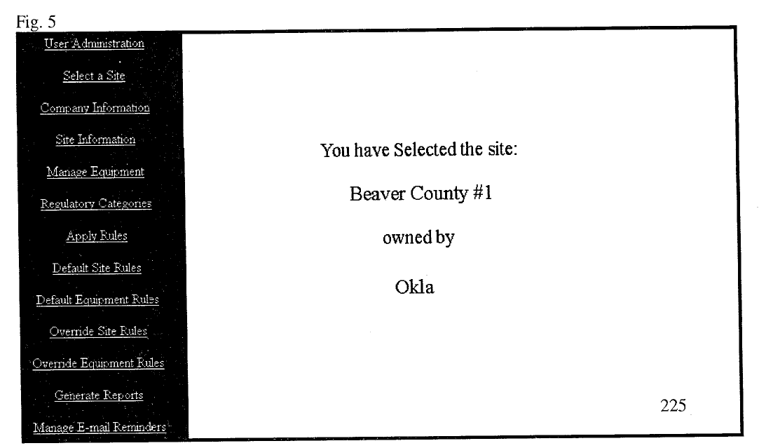

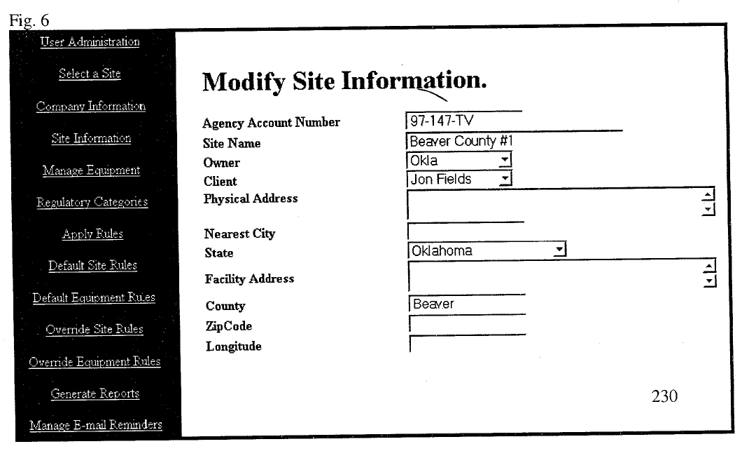

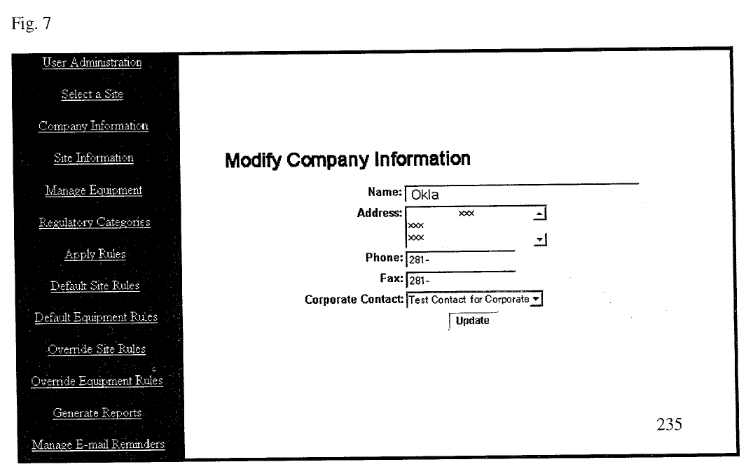

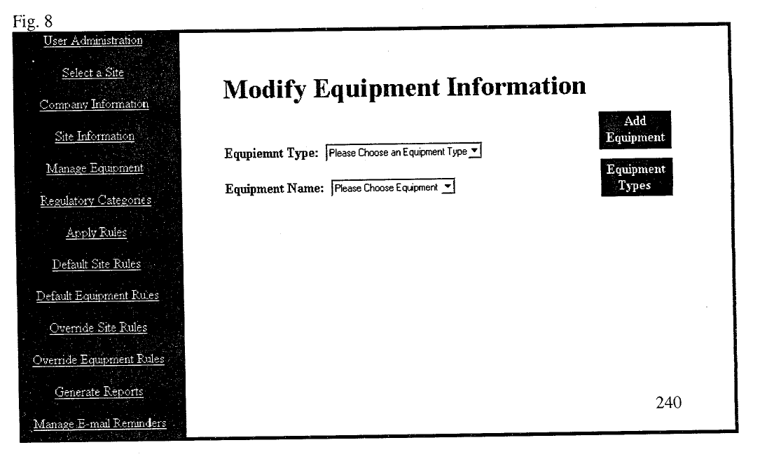

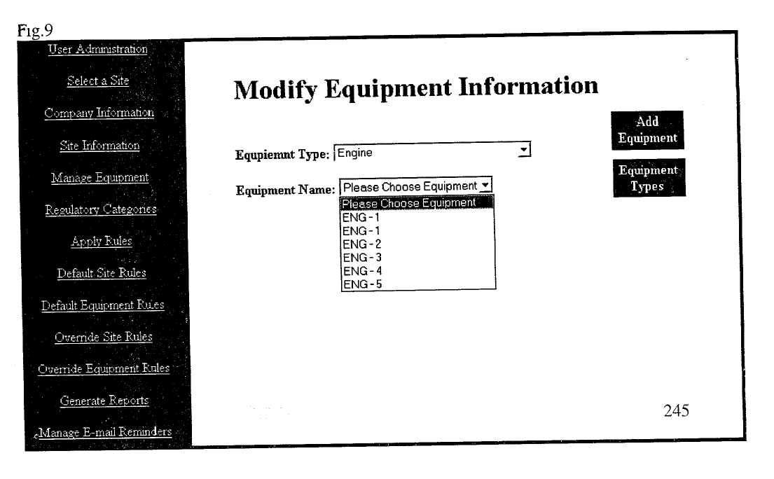

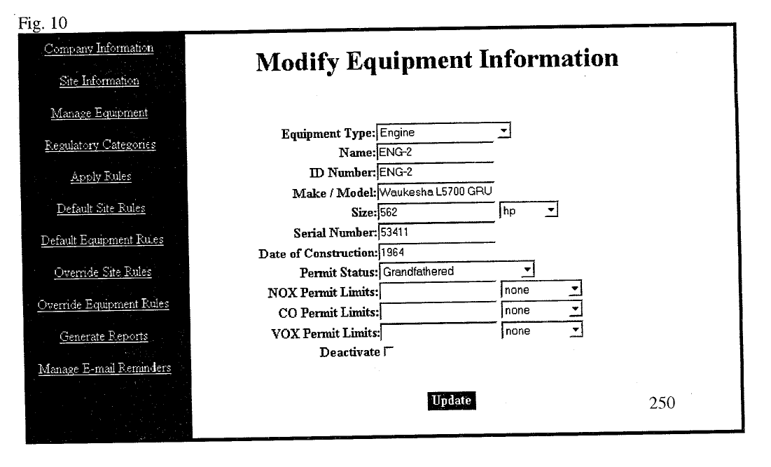

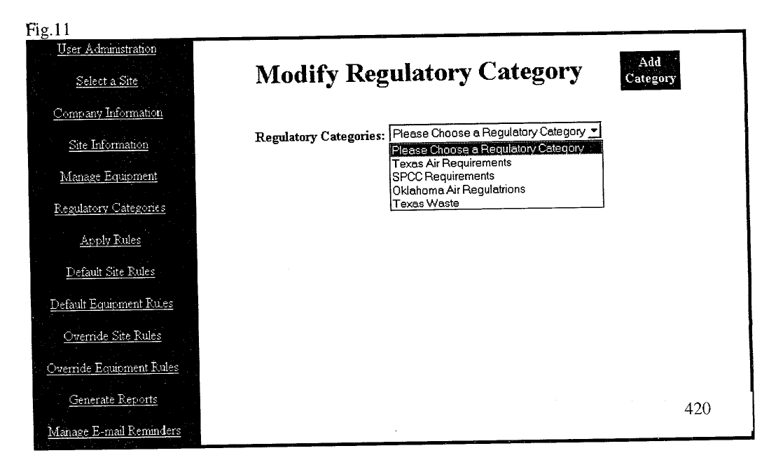

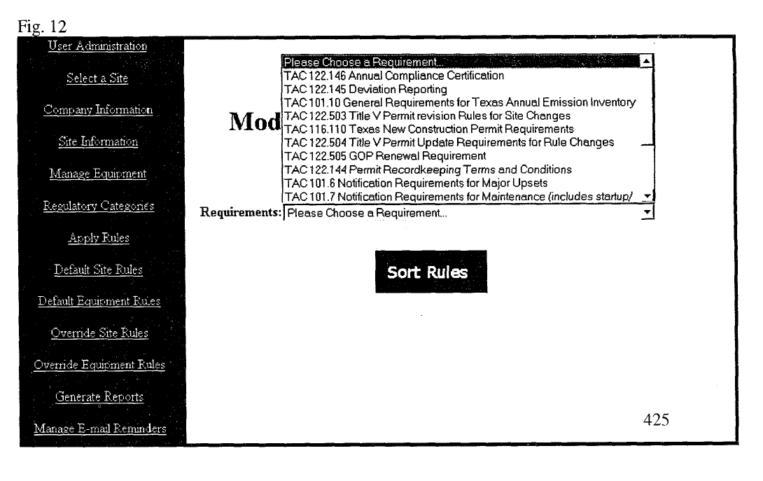

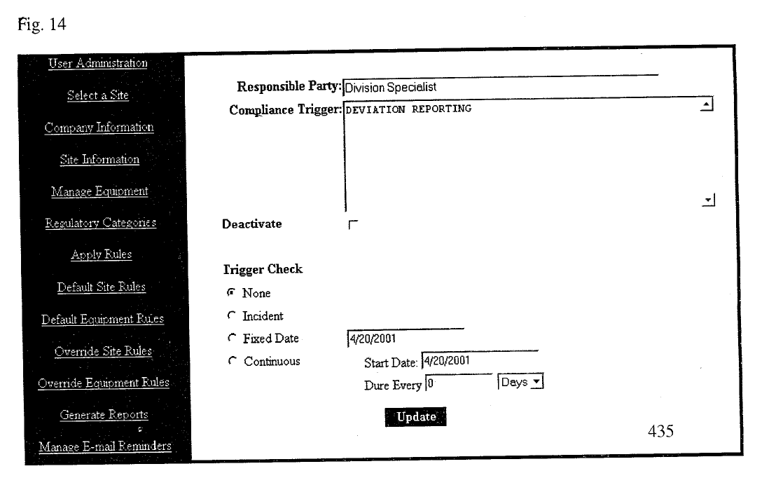

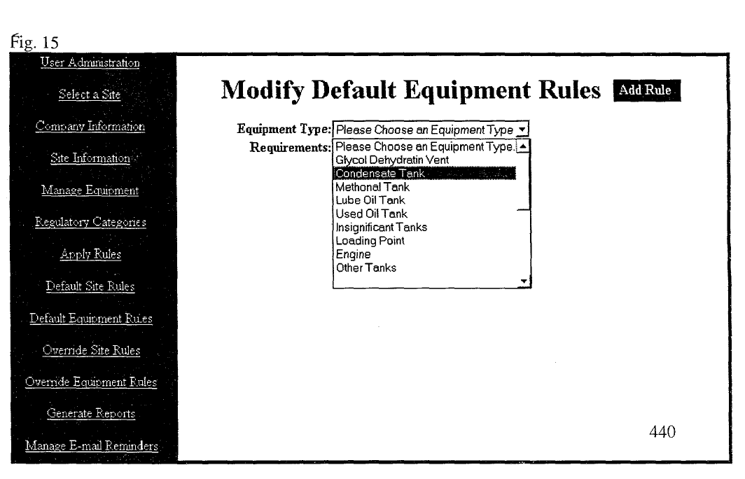

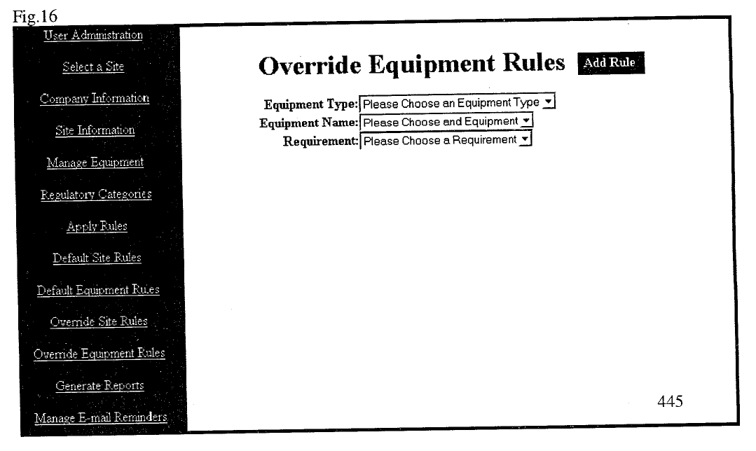

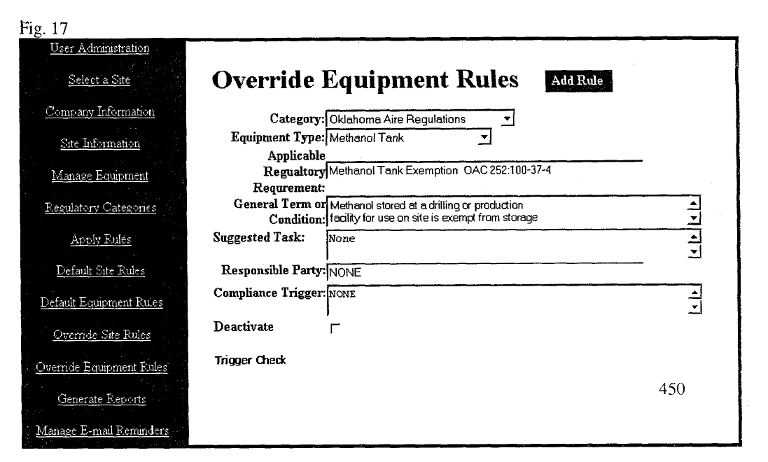

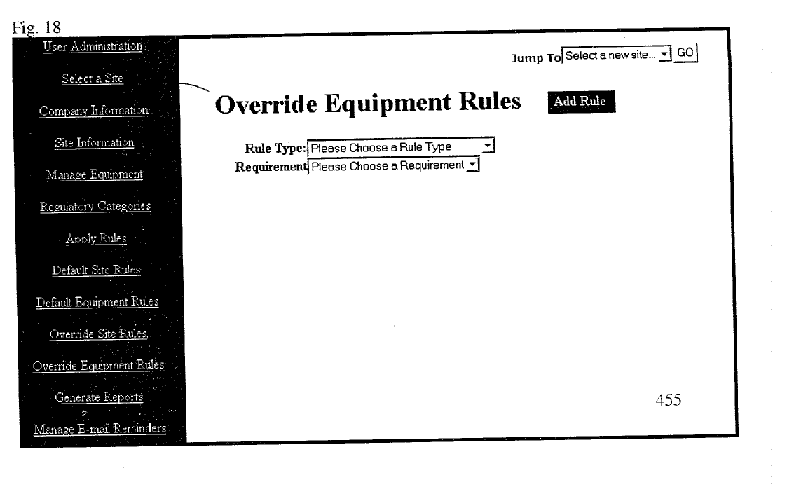

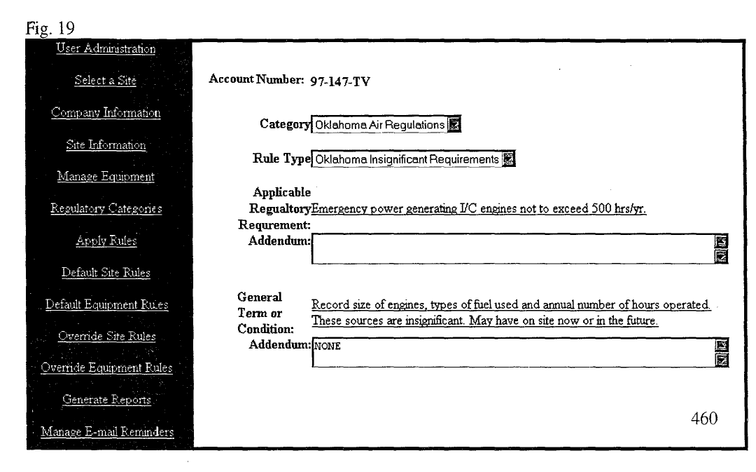

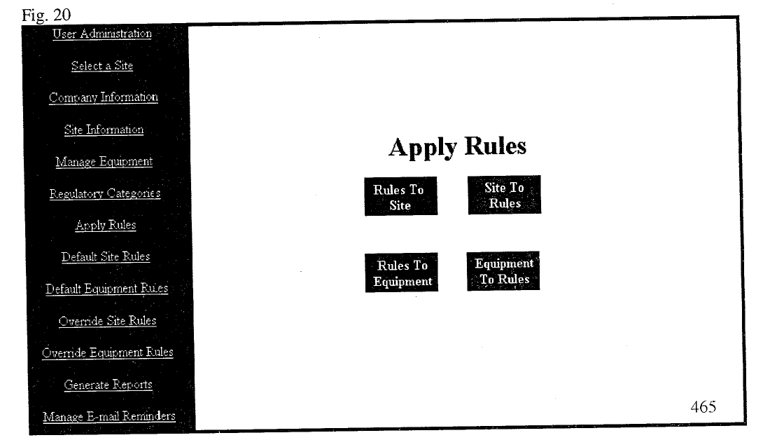

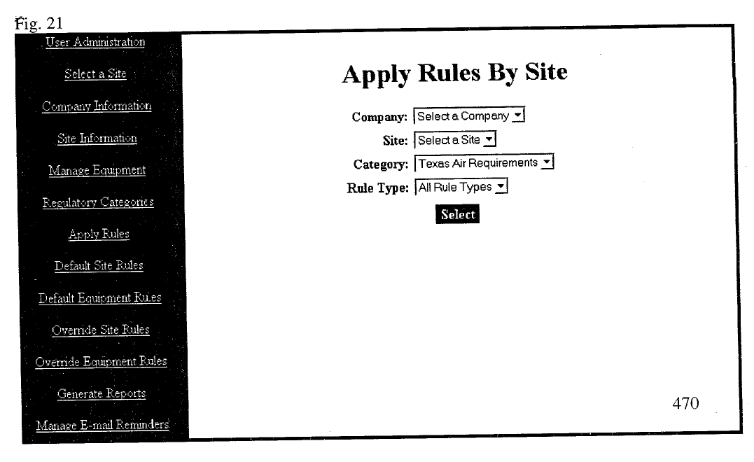

The method and system of this invention is applicable to a wide array of companies, industries, businesses and organizations that must comply with rules and regulations. For the illustrative purposes of explanation during this description, FIGS. 3 through 36 and the appendices refer to a particular plant but do not limit this method and system to any particular application. Referring to FIG. 4, the authorized user can select a site, 220, to determine its compliance requirements. The authorized user identifies facility subject items subject to regulatory compliance applicable for the specific user's company or organization, FIG. 1, 120 to determine its compliance status and requirements. The system preferably confirms the selection, 225 and allows the authorized user to modify site information 230 or company information 235. The equipment at that site can be identified 240 and information entered, updated and modified if necessary 245, 250. In one embodiment, the information can comprise name of the equipment, ID numbers, serial numbers, site location, date of construction, permit status, permit limits and any other pertinent information required to identify the equipment and insure compliance.

Once the subject item has been selected, the regulatory compliance system and method of this invention selects the applicable rules for the facility data 120 from the compliance data that is within the database 130. The step of applying rules 140 to determine regulatory compliance data for substantially each subject item identified by the authorized user is based upon regulatory compliance data 130 and subject items 120 previously entered into the one or more databases. Preferably the regulatory compliance system comprises one or more interactive functions such as a query, sort and find function for determining regulatory compliance data applicable to identified subject items. Other interactive functions such as a reminder function and a reporting function to generate reports and reminders for responsible persons are also within the preferred system.

In one embodiment of this method, the step of applying the rules using the query, sort and find functions 150 is performed by a database engine which generates compliance data for the identified subject items, the compliance data comprising regulatory compliance data for subject items input by user, applicable compliance requirements, actions required, compliance triggers necessary to fulfill compliance requirements for substantially each identified subject item including due date for taking required action and the responsible person for performing required action.

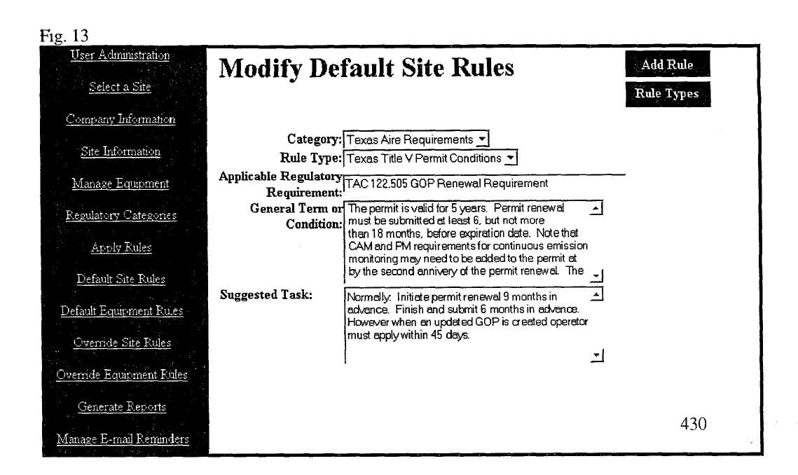

The step of applying the rules using the query, sort and find functions 150 can be automatically processed by a database engine of a computer processor or performed by a user, for example, the administrator of the system. Referring to FIGS. 12-20, the authorized client user can modify or override the default settings for the automated selection of rules by modifying regulatory categories to select specific categories 420. The requirements 425, site rules 430, and equipment rules 440-460 can also be modified so that the default settings are overruled.

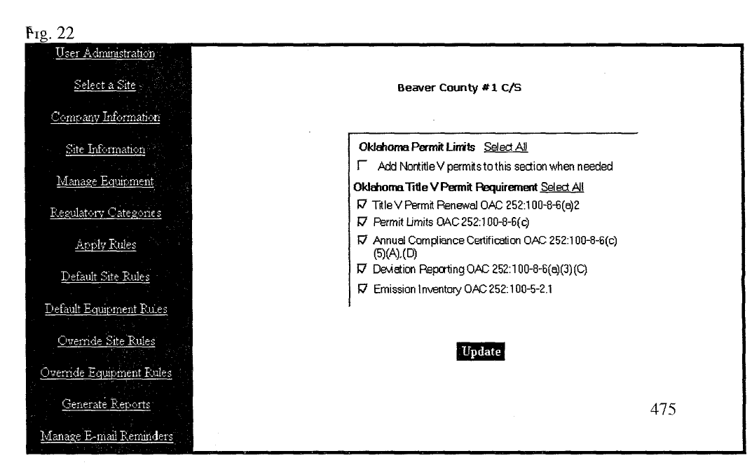

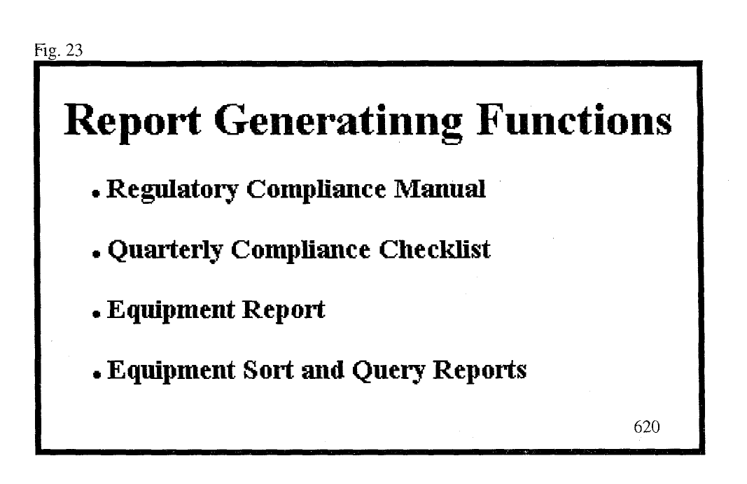

Referring to FIG. 21, the user has options of how the compliance rules are applied to the various subject items by means of a variety of functions programmed into the system. The user can apply the rules to the site, meaning that all rules to a specific site can be displayed. The rules can also be applied to a specific piece of equipment (rules to equipment) to bring up every rule in the database that applies to that piece of equipment. The functions can also list a single rule with all the equipment affected by that rule, as well a single rule and all sites affected by that rule. FIGS. 22 and 23 illustrate the function of all rules applicable to a specific site.

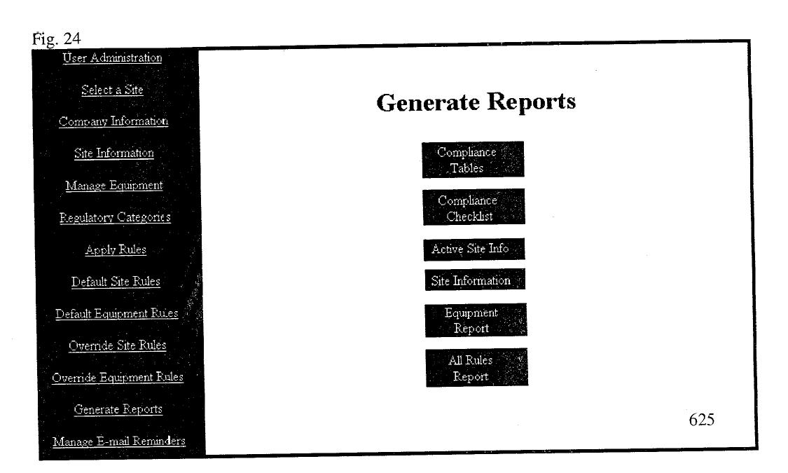

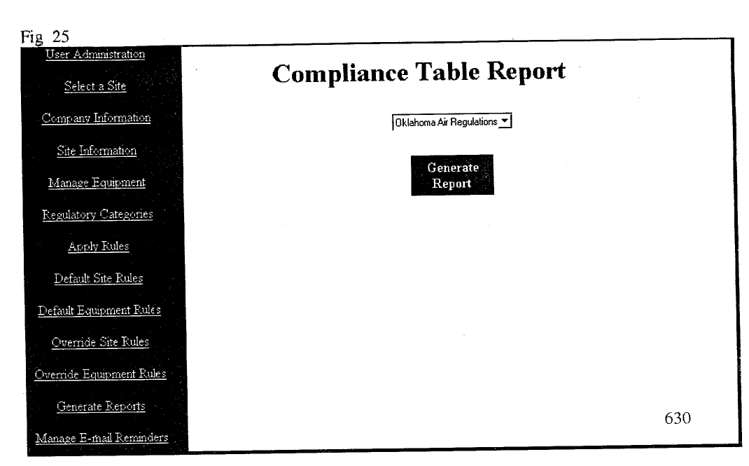

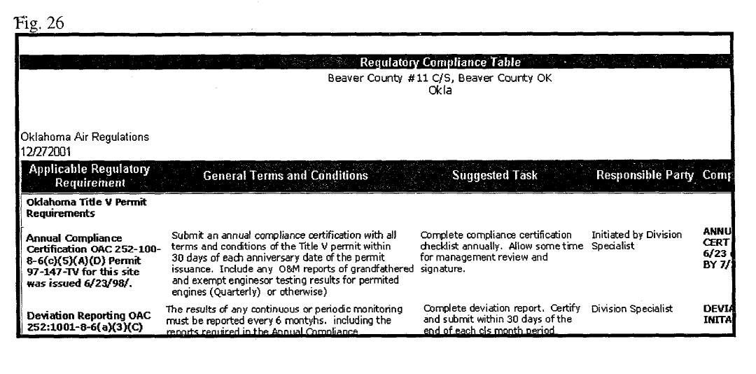

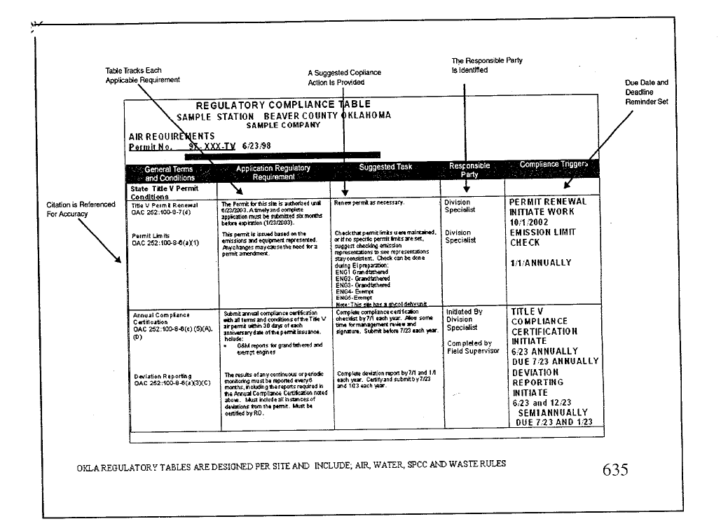

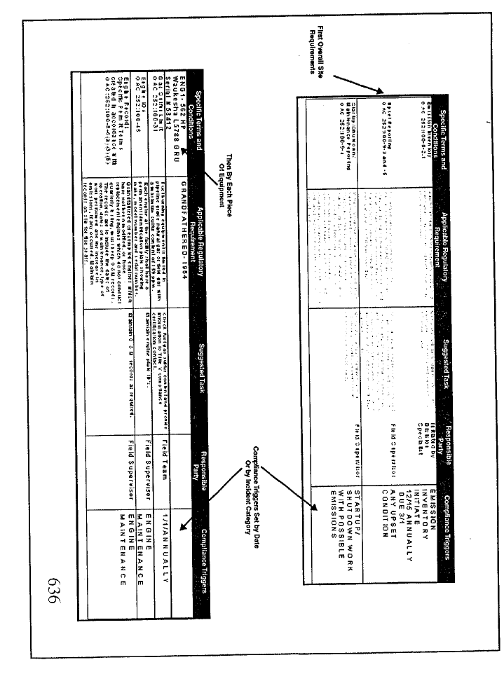

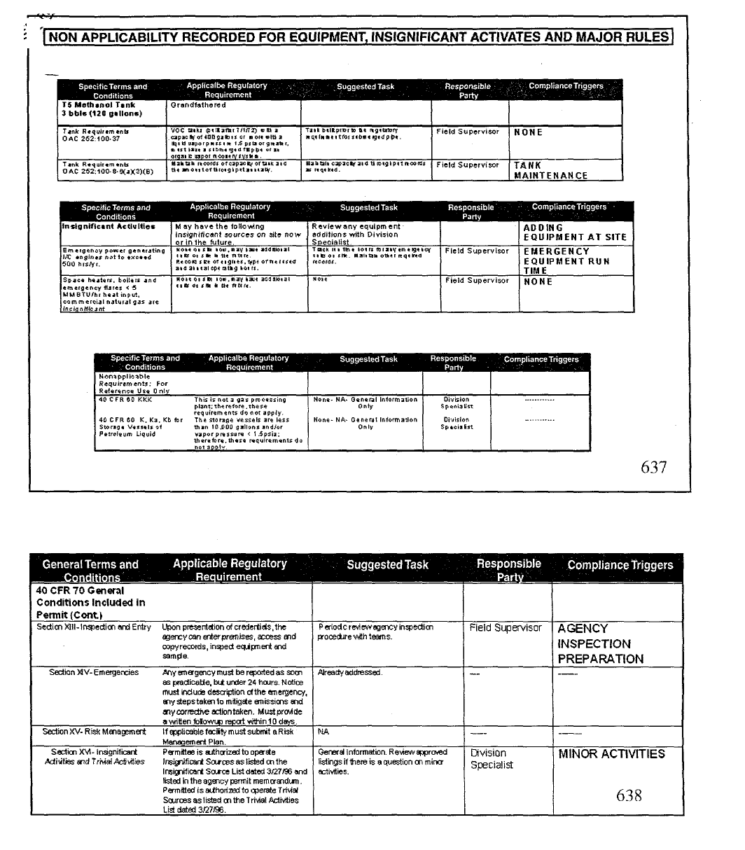

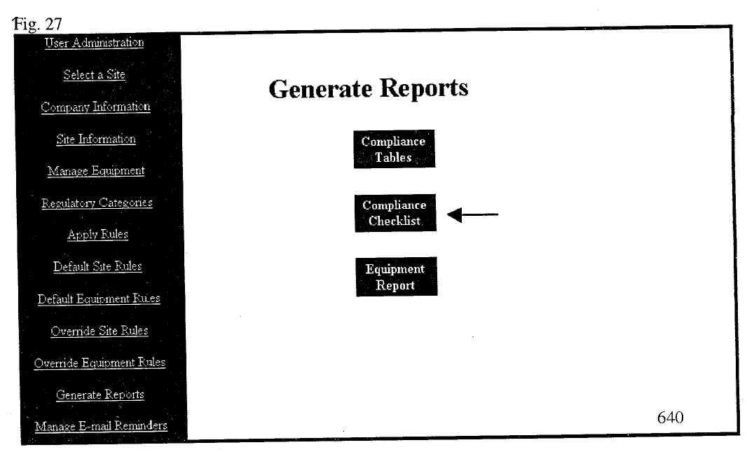

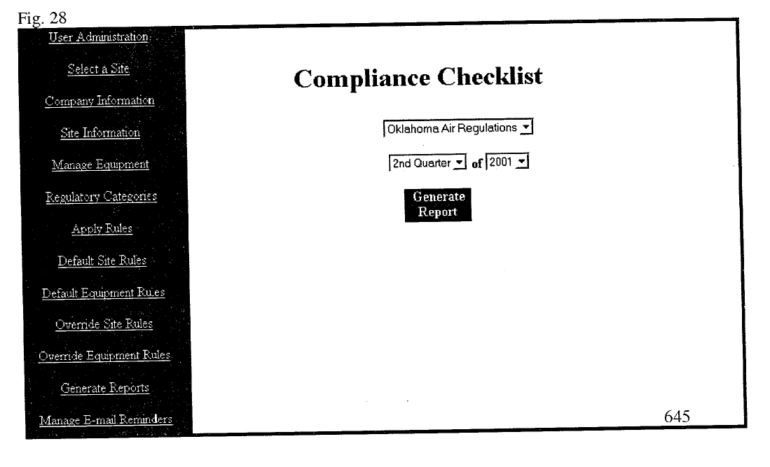

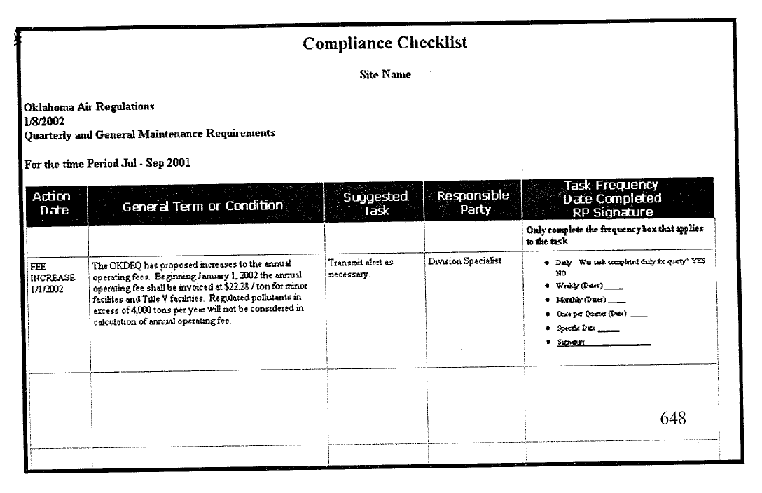

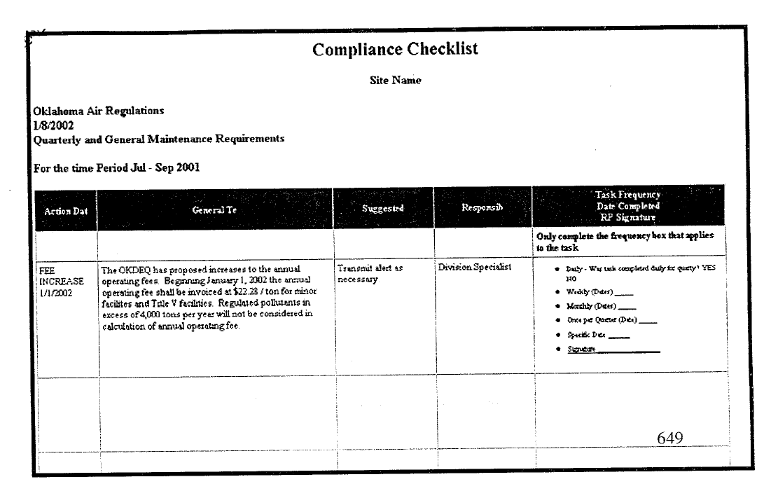

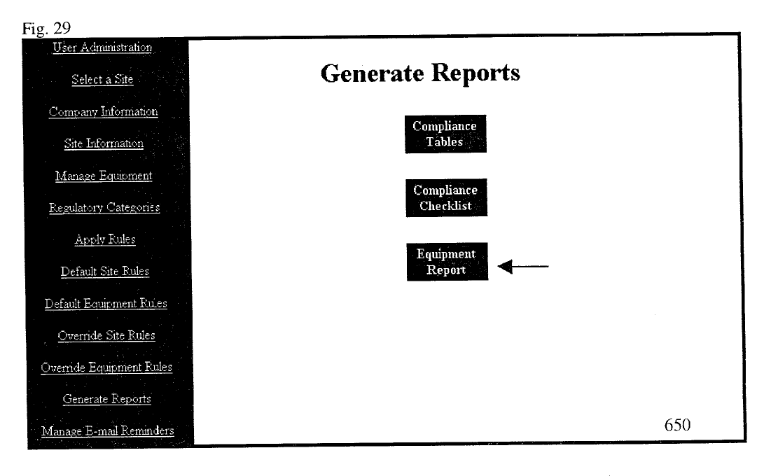

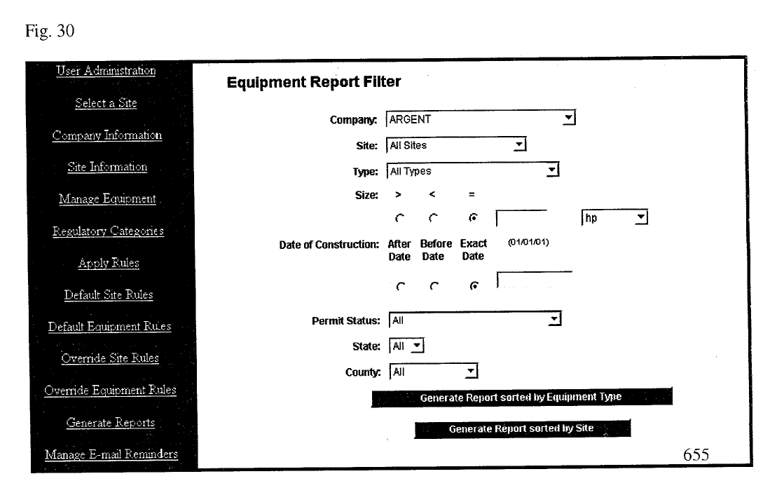

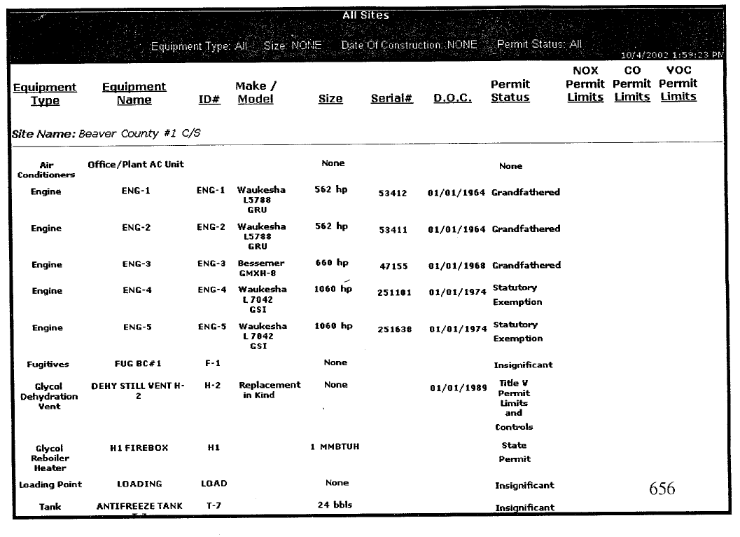

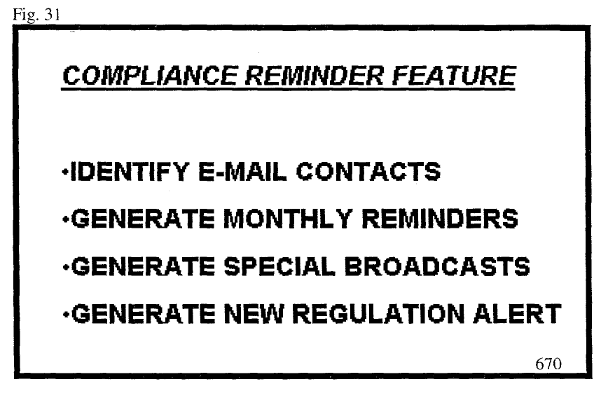

The compliance requirement data is provided to authorized users by report generators 160 that generate one or more reports and reminders 170. The authorized user can generate a report by selecting a specific reporting method 465. FIG. 24 is a webpage that notifies the authorized user of the report generating functions available, regulatory compliance, quarterly compliance checklists, an equipment report and equipment sort and query reports that can be used to inventory equipment at a facility site. The various types of data reports 180 that are available are provided to the authorized user in FIG. 25 and can comprise one or more checklists 175, one or more compliance tables, one or more equipment query reports, one or more site information reports, one or more activity site information reports, one or more equipment lists, one or more inventory reports or combinations thereof. User initiated compliance reports 173, compliance checklists 175, equipment reports 174, activity reports 176 and site and company information reports can also be generated. The authorized user can also generate a report of all the compliance rules applicable to its facility or site, (FIG. 25). FIGS. 26 to 31 illustrate the web pages for the various reports available. A compliance table report as shown in FIGS. 26 and 27 is printed in its entirety as Appendix A. As shown in FIG. 27, 635, this is a site compliance report for Air Regulations and includes applicable regulatory requirements, an explanation of the general terms and conditions for compliance, the task that must be accomplished to comply, the person responsible to complete the task and the activity triggers that initiate compliance to that regulation. A checklist can be generated so that compliance activities and the dates of compliance can be recorded. The responsible party can sign off when compliance has occurred, (FIG. 29), 645, 648, 649. FIG. 31 illustrates an equipment report that lists substantially all the equipment for all sites of a client user and the compliance rules and requirements for each piece of equipment so that the client user can have a complete inventory report of all its equipment. 650, 656.

It is important that the compliance requirement data is provided to a responsible person for carrying out compliance actions in a timely manner. The method and system of this invention provides various types of reminders to responsible parties by means of its reminder and broadcast functions 150. The system can initiate reminders based on compliance triggers 171, preferably preset compliance triggers according to due dates or other triggering functions as required by the compliance rules and regulations. FIG. 32 is a web page of the types of reminders available to responsible persons. The responsible person can be notified by email, fax, phone, regular mail or other method to timely inform the person of the compliance requirement. A broadcast function 190 can be part of this system to generate special broadcasts of computer-generated emails that can be used as reminders.

A regulatory compliance system according to this invention comprises a web site hosted by a server, the web site accessible on a local area network or the World Wide Web to multiple computers. A data structure 200 can be located on the web site comprising one or more relational databases. Preferably, the one or more relational databases 200 comprise regulatory compliance data, i.e. rules and regulations of various compliance agencies, client information data, and subject items that require regulatory compliance, the subject items comprising facility sites, equipment and activities subject to regulatory compliance. The client data can identify specific subject items and authorized user data. One or more secured, interactive web pages are available to authorized users for enabling the users to input access data for accessing compliance data relating to specific subject items.

A database engine comprising one or more query, sort and find software is accessible to authorized users. A computer security system to limit access to authorized persons is part of the regulatory compliance system and such security systems are well known. The compliance data can comprise compliance data for specific subject item comprising applicable compliance requirements, actions required, due date for performing required action and responsible person for performing required action. One or more report generators are used to generate one or more reports for specific subject items input by client user, the one or more reports comprising compliance data for one or more specific subject items input by client user. The reports can comprise one or more checklists, one or more compliance tables, one or more equipment query reports, one or more site information reports, one or more equipment lists and one or more inventory reports. The checklists can comprise substantially each subject item within the facility, one or more compliance actions required and a verification signature of the responsible person. Preferably one or more pre-set time triggers are available for each required compliance action to notify the responsible person of compliance action and its due date.

System Functions

One preferred embodiment of the system design includes the following functional components:

Administrative Data Entry

Company Information
Site information
Client E-Mail Contacts
Permit Information

Regulatory Compliance Online Tables

Complete Table Per Facility
Applicable Rule Summary for Site
and Individual Pieces of
Equipment
Recommended Compliance
Action
Identify Responsible Party for
Compliance Action
Identify Compliance Triggers
Useful for Compliance Reviews
and Certifications

User Generated Checklist

Quarterly Checklist Generated for
Any Quarter
Checklist Per Individual Facility
and Equipment
Provides Option for Completion
Verification Signature
Useful for Compliance Reviews
and Certifications

Equipment Report and Queries

Identify All Regulated Equipment
Include Complete
Description
Allows Management Queries
for Impact Analysis

Reporting

View All Information Online
Also Can Generate Hard
Copies of All Reports and
Queries

Security

Administrator Security
User Security
Reporter Security
ElS Manager Security
Management security

E-mail Notifications As Requested By
User

Environmental Contacts
Individual Site Contacts
Management Contacts

### APPLICABLE USES OF REGULATORY COMPLIANCE SYSTEM AND METHOD

The regulatory compliance system and method of this invention can be adapted for use with the following:

Environmentally On-Line Regulatory Service

DOT On-Line Regulatory Service

OSHA On-Line Requirement Service

Safety and Health On Line Requirement Service

HAZMAT On-Line Training Modules

Environmental Regulatory On-Line Training Modules

Emergency Incident Requirements Tables

MMS On Line Regulatory Reminder Service

Federal, State or Local Tax Regulatory Reminding Service

Environmental Management On-Line Training System

Mechanical Operation and Maintenance On-Line Tickler System

Environmental On-Line Interactive Training Modules

Education On-Line Interactive Training Modules

On Line Equipment Inventory Tracking and Reporting

On-Line Environmental Inspection Preparation Guidance

On Line OSHA Inspection Preparation Guidance

On Line Fleet Vehicle Requirements

On Line Management of Fleet Services-Environmental, Mechanical and Accounting, Requirements

On Line Environmental Sampling and Testing Protocol Tables

On-Line Step by Step Up to Date Requirements and Options for CEMS—Continuous Emission Monitoring Systems

Biomedical Waste Management Compliance Service For Hospitals

On-Line Waste Handling Compliance Manual For Various Industries

BroadBand Industry Requirements On Line

Environmental Compliance For Education Facilities—On Line For schools, universities and research facilities

Environmental Compliance Service For Tall Buildings—Information and Reminders

Environmental Compliance Service For Small Businesses In Houston—What you need to know and what you need to do

On-Line Environmental Compliance Service For Paints Shops

On-Line Environmental and Safety Compliance Service For Auto Shops

On-Line Environmental and Safety Compliance Service for Construction Businesses

On-Line Environmental Compliance for Airports

On-Line Environmental and Waste Management Requirements for Food Service Businesses

On-Line Regulatory Compliance Reminders for Printers

On-Line Regulatory Compliance Reminders for Dry Cleaners

Environmental Compliance for Petroleum Refineries

Environmental Compliance for Chemical Plants

Implementation of Regulatory Compliance System

In one preferred practice of this invention, the Applicant works with key client companies and organizations to identify and enter site and facility information. Field Compliance Surveys may be utilized. Applicant can interview field contacts as necessary to collect additional site data. The Applicant questions office contacts to collect regulatory history, including copies of site and equipment permits or registrations. Applicant gathers all applicable regulations for state and federal compliance requirements for each site. Local regulations and company policies and procedures are included when applicable. Applicant assigns applicabilities and explains non-applicabilities where useful. The Applicant then requests identification of Responsible Parties for various compliance tasks. Applicant can request access to technical and regulatory company or organizational contacts for review and approval of compliance deadline ‘leadtimes’, regulatory interpretations, equipment data and the finished product.

In one preferred method and system of this invention, the Applicant consistently maintains and periodically updates the website with regulatory information, agency information and any changes to compliance deadlines. Other changes to site or equipment data are made as necessary.

The foregoing description is illustrative and explanatory of preferred embodiments of the invention, and variations in the method, systems and other details will become apparent to those skilled in the art. It is intended that all such variations and modifications which fall within the scope or spirit of the appended claims be embraced thereby.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method for facilitating regulatory compliance comprising:
(a) providing a secured, interactive web site hosted by at least one computer server in communication with a computer network, the web site accessible to multiple computer processors;
(b) providing one or more databases comprising regulatory compliance data and subject items, accessibility to the one or more databases limited to authorized users;
(c) identify subject items subject to regulatory compliance applicable for a specific user;
(d) applying rules to determine regulatory compliance data for substantially each subject item identified in step (c) based upon regulatory compliance data and subject items provided into the one or more databases;
(e) providing compliance requirement data to authorized users.

2. The method of claim 1 wherein the web site is accessible on the World Wide Web.

3. The method of claim 1 wherein regulatory compliance data comprises compliance requirements data emanating from one or more laws, statutory codes, government rules, regulations, standards, procedures and guidelines of one or more regulatory authorities.

4. The method of claim 3 wherein the one or more regulatory authorities comprise government legislatures, government agencies, industry associations, and company organizations.

5. The method of claim 1 wherein regulatory compliance data further comprises recommended actions for compliance and compliance triggers.

6. The method of claim 5 wherein the step of applying the rules comprises determining the compliance requirements, required actions for compliance and compliance triggers necessary to fulfill compliance requirements for identified subject items.

7. The method of claim 1 wherein the subject items comprise facility sites, equipment and activities subject to regulatory compliance.

8. The method of claim 1 wherein the compliance requirement data is provided to authorized users by report generators that generate one or more reports.

9. The method of claim 1 wherein the reports comprise one or more checklists, one or more compliance tables, one or more equipment query reports, one or more site information reports, one or more equipment lists, one or more inventory reports or combinations thereof.

10. The method of claim 1 wherein the compliance requirement data is provided to a responsible person for carrying out compliance actions.

11. The method of claim 10 wherein the compliance requirement data is provided to a responsible person by reminders.

12. A method for facilitating regulatory compliance comprising:
(a) providing a secured, interactive web site hosted by at least one computer server in communication with a computer network, the web site located on the World Wide Web;
(b) providing one or more databases comprising regulatory compliance data and subject items, accessibility to the one or more databases limited to authorized users;
(c) identifying subject items requiring regulatory compliance for a specific user;
(d) using a computer data processor, applying rules to determine regulatory compliance data for substantially each subject item identified in step (c) based upon regulatory compliance data and subject items provided into the one or more databases;
(e) providing compliance requirement data to authorized client users.

13. The method of claim 12 wherein regulatory compliance data comprises compliance data emanating from one or more laws, statutory codes, government rules, regulations, standards, procedures or guidelines of one or more regulatory authorities.

14. The method of claim 13 wherein the one or more regulatory authorities comprise government legislatures, government agencies, industry associations, and company organizations.

15. The method of claim 13 wherein the regulatory compliance data further comprises recommended actions for compliance and compliance triggers.

16. The method of claim 12 wherein the subject items comprise facility sites, equipment and activities subject to regulatory compliance.

17. The method of claim 12 further comprising one or more interactive functions, the interactive functions comprising a query, sort and find function for determining regulatory compliance data applicable to identified subject items, a reminder function and a reporting function to generate reports and reminders for responsible persons.

18. A method for facilitating regulatory compliance comprising:
(a) providing a secured, interactive web site hosted by at least one computer server in communication with a computer network, the web site accessible on the World Wide Web;
(b) inputting regulatory compliance data and subject items into one or more relational databases; accessibility to the relational databases limited to authorized client users;
(c) identifying one or more subject items input in step (b) that are applicable to a specific user with the use of a query, sort and find function;
(d) using a computer data processor, applying rules found in the regulatory compliance data to determine compliance requirements, required actions for compliance and compliance triggers necessary to fulfill compliance requirements for substantially each identified subject item;
(e) using a report function to generate one or more reports;
(f) providing the compliance requirements, required actions and triggers to a responsible person for carrying out compliance actions;
(g) notifying the responsible person regarding compliance requirement data and compliance dates by reminders.

19. The method of claim 18 wherein the compliance requirement data is provided to a responsible person according to preset time triggers.

20. The method of claim 18 wherein the reports comprise one or more checklists, one or more compliance tables, one or more equipment query reports, one or more site information reports, one or more equipment lists, one or more inventory reports and combinations thereof.

21. A method for facilitating regulatory compliance comprising:
(a) providing a secured, interactive web site hosted by at least one computer server in communication with a computer network;
(b) providing one or more relational databases comprising regulatory compliance data and subject items, the regulatory compliance data comprising compliance requirements, compliance actions to satisfy compliance requirements and due dates for actions, the subject items comprising facility sites, equipment and activities, accessibility to the relational databases limited to authorized users;
(c) inputting data to identify a company client;
(d) identifying substantially each specific subject item at a company facility, the subject items comprising facility sites, equipment and activities into the relational database;
(e) determining substantially each compliance requirement, substantially each compliance action and the compliance date for the action required for substantially each specific subject item input in step (d);
(f) identifying the responsible person to carry out the compliance action;
(g) notifying each responsible person of substantially each required compliance action and compliance date.

22. The method of claim 21 wherein the web site is accessible on the World Wide Web.

23. The method of claim 21 wherein the web site is available on a local computer network.

24. The method of claim 21 wherein the compliance requirements, compliance action required and the compliance date for identified subject items is determined by a computer processor.

25. The method of claim 21 wherein the compliance requirements, compliance action required and the compliance date is determined by a user.

26. The method of claim 21 wherein the responsible person is notified by reminders.

27. The method of claim 21 wherein the responsible person is notified of one or more upcoming compliance dates according to preset timing triggers.

28. A method for facilitating regulatory compliance comprising:
(a) providing a secured, interactive web site hosted by at least one computer server in communication with a computer network;
(b) providing one or more databases comprising regulatory compliance data, client data and subject items, the subject items comprising facility sites, equipment and activities, accessibility to the databases limited to authorized users;
(c) inputting client-specific subject items into the one or more databases using a query, sort and find function;
(d) using a computer processor, applying rules according to the regulatory compliance data to identify compliance requirements for substantially each client-specific subject item;
(e) determining the compliance actions and due dates required for substantially each compliance requirement identified in step (d);
(f) accessing the client-specific subject items, compliance requirements and compliance action determined in step (e), accessibility to data securely limited to authorized users;
(g) generating one or more reports for client-specific subject items based on the compliance requirements, compliance actions and due dates;
(h) notifying a responsible person of the required compliance action and compliance date.

29. The method of claim 28 wherein the reports comprise one or more checklists, one or more compliance tables, one or more equipment query reports, one or more site information reports, one or more equipment lists, one or more inventory reports and combinations thereof.

30. The method of claim 28 further comprising interactive functions, the interactive functions comprising one or more query, sort and find functions, one or more report functions and one or more reminder functions.

31. A method for facilitating regulatory compliance comprising:
(i) providing a secured, interactive web site hosted by at least one computer server in communication with a computer network;
(j) providing one or more databases comprising regulatory compliance data, client information data and subject items, the subject items comprising facility sites, equipment and activities, accessibility to the databases limited to authorized client users;
(k) inputting client-specific subject items into the one or more databases using a query, sort and find function;
(l) using a computer processor, applying rules according to the regulatory compliance data to identify compliance requirements for substantially each client-specific subject item;
(m) determining the compliance actions and due dates required for substantially each compliance requirement identified in step (d);
(n) accessing the client-specific subject items, compliance requirements and compliance action determined in step (e), accessibility to data securely limited to authorized users;
(o) generating one or more reports for client-specific subject items based on the compliance requirements, compliance actions and due dates;
(p) notifying a responsible person of the required compliance action and compliance date according to preset time triggers.

32. The method of claim 31 wherein the subject items comprise facility sites, equipment and activities subject to regulatory compliance.

33 A regulatory compliance system comprising:
a web site hosted by a server, the web site accessible by multiple computers;
a data structure located on the web site, the data structure comprising one or more databases comprising regulatory compliance data and subject items;
one or more secured, interface means for enabling authorized users to input access data for identifying specific subject items located on the one or more databases;
a database engine, comprising one or more query, sort and find software, for accessing the one or more databases to generate one or more compliance requirement reports for one or more specific subject items input by user.

35. The regulatory compliance system of claim 34 further comprising one or more preset time triggers for providing compliance requirement data for the subject items to authorized users according to their due date.

36. The regulatory compliance system of claim 34 wherein the subject items comprise facility sites, equipment and activities subject to regulatory compliance.

37. The regulatory compliance system of claim 34 wherein the reports comprise one or more checklists, one or more compliance tables, one or more equipment query reports, one or more site information reports, one or more equipment lists, one or more inventory reports and combinations thereof.

38. A regulatory compliance system comprising: a secure web site hosted by a server, the web site accessible by multiple computers;
a data structure located on the web site server comprising one or more databases comprising regulatory compliance data, client information data and subject items;
one or more secured, interface means for enabling authorized users to input access data to identify specific subject items;
a database engine comprising query, sort and find functions, for accessing the database to generate data relating to specific subject items;
a report generator to generate reports based on data generated by the database engine.

39. The regulatory compliance system of claim 38 further comprising one or more preset time triggers for providing compliance requirement data for the subject items to authorized users according to the due date.

40. The regulatory compliance system of claim 38 wherein the subject items comprise facility sites, equipment and activities subject to regulatory compliance.

41. A regulatory compliance system comprising:
a web site hosted by a server, the web site accessible on the World Wide Web;
a data structure located on the web site comprising one or more relational databases, the one or more relational databases comprising regulatory compliance data, client information data, and subject items that require regulatory compliance, the subject items comprising facility sites, equipment and activities subject to regulatory compliance, the client data identifying specific subject items, the client data further comprising authorized user data;
one or more secured, interactive web pages accessible to authorized users for enabling users to input access data for accessing compliance data relating to specific subject items;
a database engine comprising one or more query, sort and find software to generate compliance data for the identified subject items, the compliance data comprising regulatory compliance data for subject items input by user, the compliance data comprising applicable compliance requirements, actions required, due date for taking required action and responsible person for performing required action.

42. A regulatory compliance system comprising:
a web site hosted by a server, the web site comprising a computer server accessible by multiple computers;
a data structure located on the web site comprising one or relational databases, the one or more relational databases comprising compliance data, subject items that require compliance, and client data, the subject items comprising facility sites, equipment and activities subject to compliance, the client data identifying specific subject items applicable to the client, the client data further comprising authorized user data;
one or more secured, interactive web pages accessible to authorized users for enabling users to input access data for accessing compliance data relating to specific subject items;
a database engine comprising one or more query, sort and find software to generate compliance data for the specific subject items input by user, the compliance data comprising compliance data for subject item, the compliance data comprising applicable compliance requirements, actions required, due date for performing required action and responsible person for performing required action; and
one or more report generators to generate one or more reports for specific subject items input by client user, the one or more reports comprising compliance data for one or more specific subject items input by client user.

43. The regulatory compliance system of claim 42 wherein the reports comprise one or more checklists, one or more compliance tables, one or more equipment query reports, one or more site information reports, one or more equipment lists and one or more inventory reports.

44. The regulatory compliance system of claim 43 wherein the checklists comprise substantially each subject item within the facility, one or more compliance actions required and a verification signature of the responsible person.

45. The regulatory compliance system of claim 42 further comprising one or more pre-set time triggers for each required compliance action to notify the responsible person of compliance action and its due date.
